(19) United States
(12) Patent Application Publication
(10) Pub. No.: US 2025/0386293 A1
(43) Pub. Date: Dec. 18, 2025

(54) ENHANCED LOW POWER WAKE-UP SIGNAL TRANSMISSION FOR NETWORK ENERGY SAVINGS

(71) Applicant: QUALCOMM Incorporated, San Diego, CA (US)

(72) Inventors: Sourjya DUTTA, San Diego, CA (US); Navid ABEDINI, Basking Ridge, NJ (US); Kapil GULATI, Belle Mead, NJ (US)

(21) Appl. No.: 18/742,847

(22) Filed: Jun. 13, 2024

(51) Int. Cl. H04W 52/02; H04W 16/28; H04W 24/10

(52) U.S. Cl. CPC H04W 52/0235; H04W 16/28; H04W 24/10

(57) ABSTRACT

Methods, systems, and devices for wireless communications are described. The described techniques may enable a network entity to determine if a user equipment (UE) is within a coverage area associated with a low-power wake-up radio (LP-WUR) of the UE prior to transmitting a low power wake-up signal (LP-WUS). For example, the network entity may obtain coverage state information including the coverage area of the LP-WUR and a location of the UE. The network entity may further determine whether the UE is likely to remain within the coverage area based on assistance information from the UE (e.g., transmitted to the network entity or another network entity). The network entity may accordingly refrain from transmitting a LP-WUS if the UE is outside of the coverage area or if the UE is likely to move outside of the coverage area.

### FIELD OF TECHNOLOGY

The following relates to wireless communications, including enhanced low power wake-up signal (LP-WUS) transmission for network energy savings.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a first network entity is described. The method may include obtaining coverage state information for a low power wake-up radio (LP-WUR) associated with a user equipment (UE), obtaining movement information associated with the UE, and transmitting, to the UE, a low power wake-up signal (LP-WUS) based on the UE being within a coverage area associated with the LP-WUR according to the coverage state information and based on the movement information associated with the UE satisfying one or more movement information thresholds.

A first network entity for wireless communications is described. The first network entity may include one or more memories storing processor executable code, and one or more processors coupled with the one or more memories. The one or more processors may individually or collectively be operable to execute the code to cause the first network entity to obtain coverage state information for a LP-WUR associated with a UE, obtain movement information associated with the UE, and transmit, to the UE, a LP-WUS based on the UE being within a coverage area associated with the LP-WUR according to the coverage state information and based on the movement information associated with the UE satisfying one or more movement information thresholds.

Another first network entity for wireless communications is described. The first network entity may include means for obtaining coverage state information for a LP-WUR associated with a UE, means for obtaining movement information associated with the UE, and means for transmitting, to the UE, a LP-WUS based on the UE being within a coverage area associated with the LP-WUR according to the coverage state information and based on the movement information associated with the UE satisfying one or more movement information thresholds.

A non-transitory computer-readable medium storing code for wireless communications is described. The code may include instructions executable by one or more processors to obtain coverage state information for a LP-WUR associated with a UE, obtain movement information associated with the UE, and transmit, to the UE, a LP-WUS based on the UE being within a coverage area associated with the LP-WUR according to the coverage state information and based on the movement information associated with the UE satisfying one or more movement information thresholds.

In some examples of the method, first network entities, and non-transitory computer-readable medium described herein, transmitting the LP-WUS may include operations, features, means, or instructions for transmitting the LP-WUS according to a LP-WUS configuration, where the LP-WUS configuration includes a coding rate, a transmission power, or a quantity of repetitions, or any combination thereof.

Some examples of the method, first network entities, and non-transitory computer-readable medium described herein may further include operations, features, means, or instructions for selecting the LP-WUS configuration based on the coverage state information and the movement information.

In some examples of the method, first network entities, and non-transitory computer-readable medium described herein, transmitting the LP-WUS may include operations, features, means, or instructions for transmitting the LP-WUS in one or more beam directions, where the one or more beam directions may be based on the coverage state information and the movement information.

In some examples of the method, first network entities, and non-transitory computer-readable medium described herein, obtaining the coverage state information may include operations, features, means, or instructions for obtaining, from the UE, a message indicating the coverage state information.

In some examples of the method, first network entities, and non-transitory computer-readable medium described herein, obtaining the coverage state information may include operations, features, means, or instructions for obtaining one or more measurement reports from the UE, where the one or more measurement reports indicate the coverage state information.

In some examples of the method, first network entities, and non-transitory computer-readable medium described herein, obtaining the coverage state information may include operations, features, means, or instructions for obtaining, from a second network entity, a message indicating the coverage state information.

In some examples of the method, first network entities, and non-transitory computer-readable medium described herein, obtaining the movement information may include operations, features, means, or instructions for obtaining, from the UE, a message indicating the movement information.

In some examples of the method, first network entities, and non-transitory computer-readable medium described herein, obtaining the movement information may include operations, features, means, or instructions for obtaining, from a second network entity, a message indicating the movement information.

Some examples of the method, first network entities, and non-transitory computer-readable medium described herein may further include operations, features, means, or instructions for outputting a message indicating for the UE to provide, to the first network entity or to a second network entity, the movement information, the coverage state information, or both.

In some examples of the method, first network entities, and non-transitory computer-readable medium described herein, the movement information includes a likelihood that the UE will remain within the coverage area, a time during which the UE will remain within the coverage area, or both and the one or more movement information thresholds include a threshold likelihood, a threshold time, or both.

In some examples of the method, first network entities, and non-transitory computer-readable medium described herein, the coverage state information includes a size of the coverage area, an indication of whether the UE may be within the coverage area, an estimated pathloss, an estimated reference signal received power (RSRP), a distance from the UE to the first network entity, one or more divisions of the coverage area, or any combination thereof.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports enhanced low power wake-up signal (LP-WUS) transmission for network energy savings in accordance with one or more aspects of the present disclosure.

FIG. 2 shows an example of a network architecture that supports enhanced LP-WUS transmission for network energy savings in accordance with one or more aspects of the present disclosure.

FIG. 3 shows an example of a wireless communications system that supports enhanced LP-WUS transmission for network energy savings in accordance with one or more aspects of the present disclosure.

FIG. 4 shows an example of a process flow that supports enhanced LP-WUS transmission for network energy savings in accordance with one or more aspects of the present disclosure.

FIGS. 5 and 6 show block diagrams of devices that support enhanced LP-WUS transmission for network energy savings in accordance with one or more aspects of the present disclosure.

FIG. 7 shows a block diagram of a communications manager that supports enhanced LP-WUS transmission for network energy savings in accordance with one or more aspects of the present disclosure.

FIG. 8 shows a diagram of a system including a device that supports enhanced LP-WUS transmission for network energy savings in accordance with one or more aspects of the present disclosure.

FIGS. 9 and 10 show flowcharts illustrating methods that support enhanced LP-WUS transmission for network energy savings in accordance with one or more aspects of the present disclosure.

### DETAILED DESCRIPTION

In some wireless communications systems, a user equipment (UE) may operate in a low power mode in which the UE (or some power consuming components of the UE) may be inactive for a duration (e.g., a sleep duration). In some examples, the UE may use a low power wake-up radio (LP-WUR) to receive one or more signals (e.g., wake-up signals (WUSs)) from a network entity during such an inactive or sleep duration. For example, the LP-WUR may receive a WUS instructing or indicating for the UE to enter an active mode (e.g., to wake up) to receive one or more signals via a main radio (MR) of the UE. In some examples, however, the LP-WUR of the UE may have a relatively smaller coverage area than the MR of the UE. Accordingly, the network entity may transmit the LP-WUS when the UE is within a coverage area of the MR, but not within the coverage area of the LP-WUR. The network entity may accordingly transmit a LP-WUS that may not be received by the UE, which may increase power usage at the network entity and waste communication resources.

Accordingly, techniques described herein may enable the network entity (e.g., a distributed unit (DU)) to determine if the UE is within the coverage area of the LP-WUR prior to transmitting the LP-WUS. For example, the network entity may obtain coverage state information including the coverage area of the LP-WUR and a location of the UE (e.g., from another network entity, such as a central unit (CU), or from the UE). The DU or CU may determine this coverage state information based on measurement reports from the UE, or by an explicit indication from the UE. The network entity may determine whether the UE is stationary or pseudo-stationary (e.g., likely to remain within the coverage area over a given duration of time) based on assistance information from the UE (e.g., transmitted to the network entity or another network entity, such as the CU). The network entity may accordingly refrain from transmitting a LP-WUS if the UE is outside of the coverage area or if the UE is likely to move outside of the coverage area.

Aspects of the disclosure are initially described in the context of wireless communications systems. Aspects of the disclosure are further illustrated by and described with reference to network architectures, process flows, apparatus diagrams, system diagrams, and flowcharts that relate to enhanced LP-WUS transmission for network energy savings.

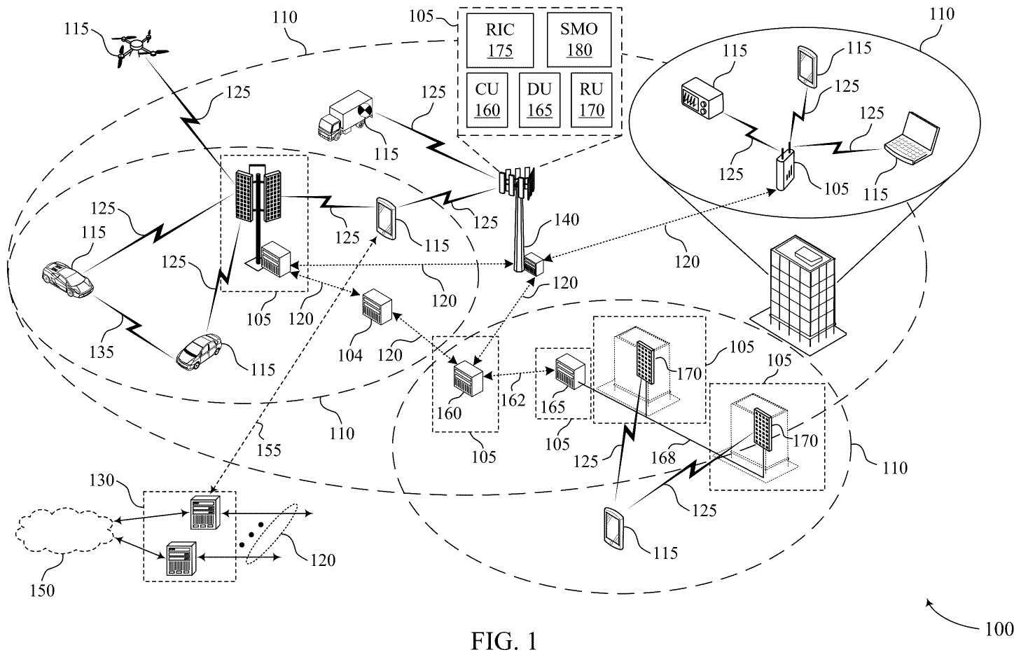

FIG. 1 shows an example of a wireless communications system 100 that supports enhanced LP-WUS transmission for network energy savings in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 or network entities 105 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 or network entities 105 may include entering a power saving deep sleep mode when not engaging in active communications, operating using a limited bandwidth (e.g., according to narrowband communications), or a combination of these techniques. For example, some UEs 115 or network entities 105 may be configured for operation using a narrowband protocol type that is associated with a defined portion or range (e.g., set of subcarriers or resource blocks (RBs)) within a carrier, within a guard-band of a carrier, or outside of a carrier. In some examples, network entities 105 may be configured to reduce power consumption by refraining from transmitting signals (e.g., LP-WUSs) to UEs 115.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some examples of the wireless communications system 100, a network entity 105 may determine if a UE 115 is stationary. The network entity 105 may generate a recommended paging synchronization signal block (SSB) list (e.g., a list of SSBs or beam directions in which the network entity 105 identifies stationary or pseudo-stationary UEs 115), and may provide the list of SSBs to a second network entity 105 (e.g., a CU 160). The second network entity 105 may provide the list of SSBs to the network entity 105 at a time at which the network entity 105 may page one or more UEs 115, and the network entity 105 may accordingly transmit paging messages in one or more beam directions indicated by the list. Such techniques may enable the network entity 105 to transmit paging messages in relatively fewer beam directions, which may decrease power consumption at the network entity 105.

Techniques described herein may enable a network entity 105 (e.g., a DU) to determine if a UE 115 is within the coverage area of a LP-WUR of the UE 115 prior to transmitting a LP-WUS. For example, the network entity 105 may obtain coverage state information including the coverage area of the LP-WUR and a location of the UE 115 (from another network entity 105, such as a CU). The DU or CU may determine this coverage state information based on measurement or reports from the UE 115, or by an explicit indication from the UE 115. The network entity may further determine whether the UE 115 is stationary or pseudo-stationary (e.g., likely to remain within the coverage area) based on assistance information from the UE 115 (e.g., transmitted to the network entity 105 or another network entity 105, such as the CU). The network entity 105 may accordingly refrain from transmitting a LP-WUS if the UE 115 is outside of the coverage area or if the UE 115 is likely to move outside of the coverage area.

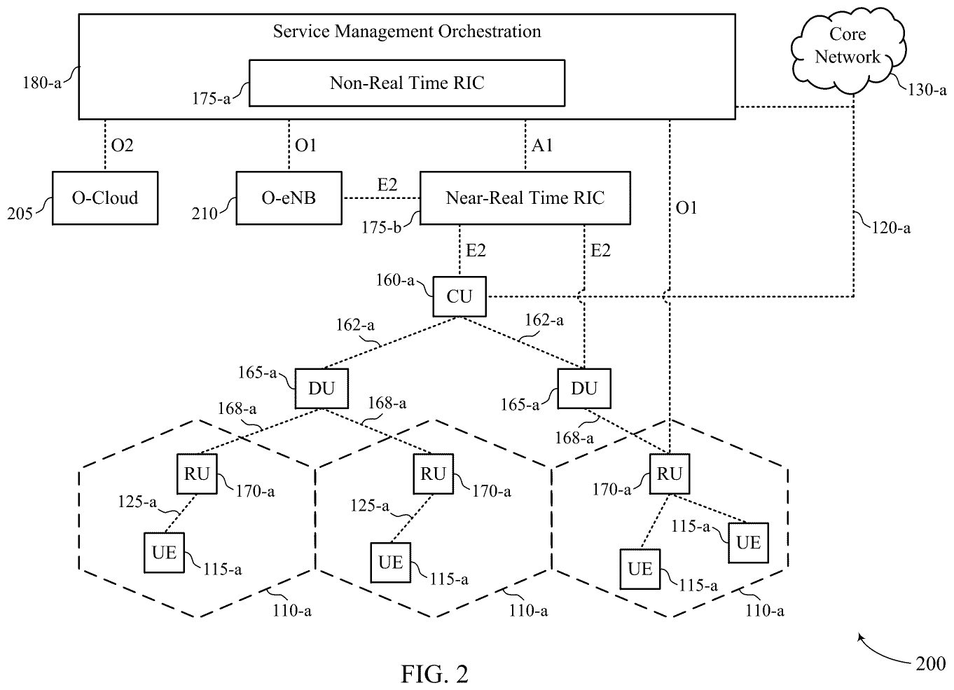

FIG. 2 shows an example of a network architecture 200 (e.g., a disaggregated base station architecture, a disaggregated RAN architecture) that supports enhanced LP-WUS transmission for network energy savings in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an 02 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

In some examples, a CU 160-a or a DU 165-a may determine if a UE 115-a is within the coverage area of a LP-WUR of the UE 115-a prior to transmission of a LP-WUS by an RU 170-a, for instance. A CU 160-a or a DU 165-a may obtain coverage state information including the coverage area of the LP-WUR and a location of the UE 115-a. The CU 160-a or DU 165-a may determine the coverage state information based on measurement or reports from the UE 115-a, or by an explicit indication from the UE 115-a. The CU 160-a or DU 165-a may further determine whether the UE 115-a is stationary or pseudo-stationary (e.g., likely to remain within the coverage area, such as moving within the coverage area in a direction or at a speed that satisfies a threshold) based on assistance information from the UE 115-a (e.g., transmitted to the CU 160-a, the DU 165-a, or the RU 170-a). The RU 170-a may accordingly refrain from transmitting a LP-WUS if the UE 115-a is outside of the coverage area or if the UE 115-a is likely to move outside of the coverage area at a given time.

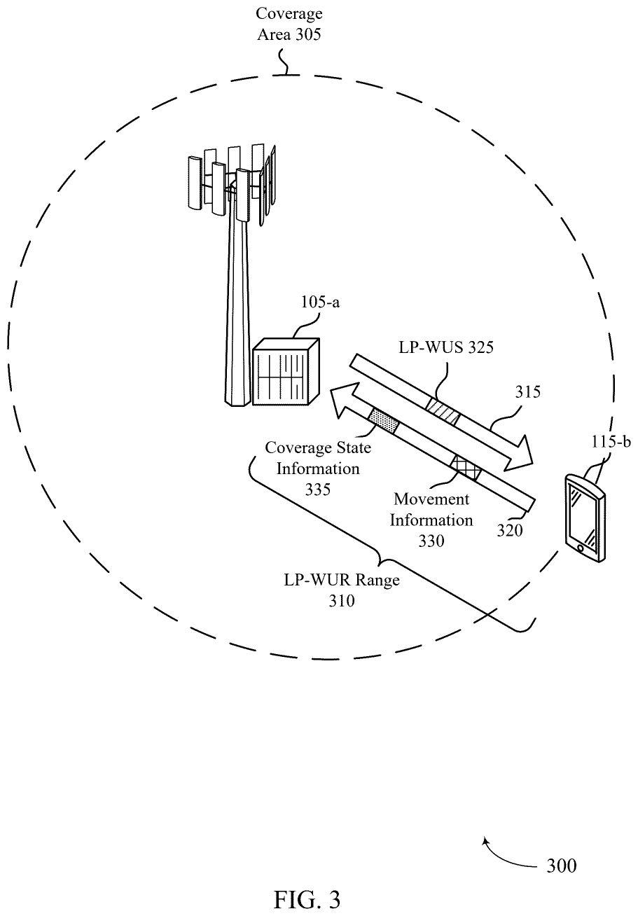

FIG. 3 shows an example of a wireless communications system 300 that supports enhanced LP-WUS transmission for network energy savings in accordance with one or more aspects of the present disclosure. The wireless communications system 300 may implement or may be implemented by aspects of the wireless communications system 100 or the network architecture 200. For example, the wireless communications system 300 may be implemented by a UE 115 (e.g., a UE 115-b) or a network entity 105 (e.g., a network entity 105-a), which may be examples of the corresponding devices as described with reference to FIG. 1. In some examples, the network entity 105-a may be an example of a DU 165 or a CU 160, as described with reference to FIG. 2.

In some examples of the wireless communications system 300, a UE 115-b may receive signaling (e.g., NR signaling) from a network entity 105-a via a downlink channel 315 using a main radio of the UE 115-b. The UE 115-b may transmit one or more messages to the network entity 105-a via an uplink channel 320. The network entity 105-a may be an example of a DU 165 as described herein with reference to FIG. 2.

In some examples, the UE 115-b may operate in a low power mode. For example, the UE 115-b may operate in an idle or inactive state (e.g., a state in which the main radio of the UE 115-b not powered for one or more periods of time) that may result in relatively less power consumption than an active state (e.g., a state in which the main radio of the UE 115-b is powered). The UE 115-b may accordingly include a LP-WUR that may receive one or more signals (e.g., a LP-WUS 325 indicating for the UE 115-b to “wake up” during one or more paging occasions to receive one or more paging messages) when the UE 115-b is in the idle state. The LP-WUR may be an RF envelope detector based radio (e.g., with relatively low complexity), an orthogonal frequency division multiple access (OFDMA) based radio (e.g., with relatively higher complexity), or another radio that may receive low power signals from the network entity 105-a. In some examples, the LP-WUR may operate using continuous detection (e.g., where the UE 115-b may continuously monitor for the LP-WUS 325) or duty-cycle based detection (e.g., where the UE 115-b may be configured with fixed slots for receiving the LP-WUS 325).

In some examples, the UE 115-a may indicate support of the LP-WUS 325 to the network entity 105-a. For example, the UE 115-a may indicate a static capability of the UE 115-a to receive the LP-WUS 325 (e.g., and an indication of an LP-WUR range 310) along with one or more other capabilities of the UE 115-b. In some examples, for a distributed architecture (e.g., with one or more other network entities 105, such as DUs 165, CUs 160, and AMFs), the network entity 105-a may exchange the capability information of the UE 115-b with the one or more other network entities 105. The network entity 105-a may provide configurations associated with the LP-WUS 325 (e.g., LP-WUS monitoring occasions) to the UE 115-b (e.g., if the network entity 105-a supports LP-WUS for idle or inactive states). Accordingly, the network entity 105-a may include an LP-WUS feature that may transmit an LP-WUS 325 (e.g., in multiple beam directions) to page the UE 115-a (e.g., in a given area, such as a tracking area (TA) or a RAN-based notification area (RNA)) if the UE 115-a is an LP-WUS-capable UE 115.

The network entity 105-a may be a network energy saving (NES) cell that may perform one or more operations to reduce power consumption at the network entity 105-a. For example, the network entity 105-a may restrict paging to a set of one or more beams in one or more beam directions (e.g., if the UE 115-b is stationary) or confine paging occasions in a time domain to reduce power consumption of the network entity 105-a. In such examples, transmitting the LP-WUS 325 may increase power consumption at the network entity 105-a. Accordingly, if the UE 115-a is not capable of receiving the LP-WUS 325, the network entity 105-a may skip transmission of the LP-WUS 325 to reduce power consumption.

The LP-WUR of the UE 115-b may have relatively more limited coverage than the main radio of the UE 115-b. For example, the LP-WUR may have an LP-WUR range 310 in which the LP-WUR may receive signaling, and a capability of the UE 115-b to receive the LP-WUS 325 may change depending on the location of the UE 115-b. The LP-WUR range 310 may be relatively smaller than a range associated with the main radio of the UE 115-b. The network entity 105-a may therefore have a coverage area 305 associated with the LP-WUR that may be relatively smaller than another coverage area of the network entity 105-a. For example, a radius of the coverage area 305 may be the LP-WUR range 310.

The UE 115-b may not receive the LP-WUS 325 via the LP-WUR when the UE 115-b is outside of the coverage area 305. Accordingly, in some examples, the UE 115-b in the idle or inactive mode may transition from the an ultra-deep sleep state-based discontinuous reception (DRX) to a traditional DRX or extended DRX (eDRX) when the UE 115-b is outside of the coverage area 305. The LP-WUS 325 may additionally be affected by adjacent channel interference (e.g., from one or more signals transmitted via channels adjacent to a carrier bandwidth used to transmit the LP-WUS 325). Accordingly, if the UE 115-b or is unaware of whether the UE 115-b is within the coverage area 305, the UE 115-b may experience relatively lower power savings (e.g., increased power consumption) or missing data as a result of not receiving the LP-WUS 325. Additionally, the network entity 105-a may transmit the LP-WUS 325 when the UE 115-b is outside of the coverage area 305, which may increase power consumption at the network entity 105-a.

In some examples, the UE 115-b may be aware of whether the UE 115-b is within the coverage area 305. However, in examples in which the UE 115-b is in the idle or inactive mode, the UE 115-b may not indicate to the network entity 105-a whether the UE 115-b is able to monitor for the LP-WUS 325 (e.g., whether the UE 115-b is within the coverage area 305).

Accordingly, techniques described herein may enable the network entity 105-a to determine whether to transmit the LP-WUS 325 based on coverage state information 335 and movement information 330 of the UE 115-b. For example, the network entity 105-a (e.g., or another network entity 105, such as a CU 160 or AMF) may determine a coverage region (e.g., coverage range, coverage state, the coverage area 305) of the UE 115-b. The UE 115-b (e.g., or one or more network entities 105, such as the network entity 105-a or a CU 160) may determine coverage state information 335 such as whether the UE 115-b is in LP-WUS range (e.g., within the coverage area 305), a reference signal received power (RSRP) margin (e.g., a quantity of decibels (dB) or transmit power reduction the network entity 105-a may use based on a distance between the UE 115-b and the network entity 105-a), a range of pathlosses (e.g., an estimated pathloss), a range of RSRPs (e.g., an estimated RSRP), a distance between the UE 115-b and the network entity 105-a, one or more logical or physical areas dividing the coverage area 305, a size of the coverage area 305 or the LP-WUR range 310, and so on.

The UE 115-b may transmit one or more connected-mode measurements or reports to the network entity 105-a (e.g., a DU 165) or one or more L3 connected-mode measurements or reports to a CU 160 indicating the coverage state information 335 (e.g., or information from which the network entity 105-a or the CU 160 may determine the coverage state information 335). Additionally, or alternatively, the UE 115-b may determine the coverage state information 335 and transmit an explicit indication of the coverage state information 335 to the network entity 105-a or the CU 160. The CU 160 may indicate the coverage state information to the network entity 105-a (e.g., in examples in which the UE 115-b provides the coverage state information 335 to the CU 160).

The network entity 105-a may use the coverage state information 335 to determine whether the LP-WUS 325 should be sent to the UE 115-b (e.g., at a given time, such as during a paging occasion) or to determine one or more parameters for transmitting the LP-WUS 325. For example, the network entity 105-a may use the coverage state information 335 to determine one or more beam directions in which the network entity 105-a may transmit the LP-WUS 325 or a configuration for transmitting the LP-WUS 325 (e.g., a transmit power, a quantity of repetitions, a coding rate, and the like) based on the coverage state information 335. For example, if the coverage state information 335 indicates that the UE 115-b may receive the LP-WUS 325 with a link budget that is an amount X lower than a link budget of a UE 115 at an edge of the coverage area 305, the network entity 105-a may transmit the LP-WUS 325 to the UE 115-b with a relatively lower transmit power (e.g., X dB lower) than for the UE 115 at the edge of the coverage area 305.

In some examples, the UE 115-b may be a stationary UE 115 or a pseudo-stationary UE 115 (e.g., a UE 115 that may be likely to use the LP-WUS 325 when the UE 115 transitions into an inactive or idle state). As described herein, a pseudo-stationary UE 115 may be a UE 115 that has a tendency to remain in a same region or state (e.g., within the coverage area 305). That is, the UE 115-b may not be mobile, may have a speed that is below a threshold speed, or may have a likelihood that the UE 115-b may move from within the coverage area 305 to outside of the coverage area 305 that is less than a threshold likelihood.

In some examples, the UE 115-b may transmit movement information 330 to the network entity 105-a (e.g., or another network entity 105, such as a CU 160) indicating whether the UE 115-b is stationary, pseudo-stationary, or mobile as part of a recommendation for whether the network entity 105-a may transmit the LP-WUS 325. For example, the UE 115-b may indicate a speed of the UE 115-b, a likelihood that the UE 115-b may move from within the coverage area 305 to outside of the coverage area 305, a tendency of the UE 115-b to remain in a same coverage area (e.g., a same coverage region or state), or information that may be indicative of the speed or likelihood to the network entity 105-a (e.g., or to another network entity 105, such as a CU 160). In some examples, the movement information 330 may include one or more time-related attributes, such as an expected time (e.g., a minimum or maximum time) during which the UE 115-b may remain inside or outside of the coverage area 305.

In some examples, the UE 115-b may provide the movement information 330 to the network entity 105-a, a CU 160, a core network, or one or more other network entities 105 as LP-WUS-related configuration information, as assistance information (e.g., while the UE 115-b is in a connected mode), and the like. For example, the UE 115-b may transmit the movement information 330 (e.g., or information from which the network entity 105-a or the CU 160 may determine the movement information 330) to the network entity 105-a or to the CU 160. In examples in which the UE 115-b provides the movement information 330 to the CU 160 or to one or more other network entities 105, the network entity 105-a may obtain the movement information 330 from the CU 160 or from the one or more other network entities 105 (e.g., via one or more interfaces between network entities 105, such as backhaul signaling).

Accordingly, the network entity 105-a may determine if the UE 115-b is within the coverage area 305 and if the UE 115-b is stationary or pseudo-stationary. The network entity 105-b may determine whether to transmit the LP-WUS 325 based on the movement information 330 and the coverage state information 335. For example, if the UE 115-b is within the coverage area 305 and likely to remain within the coverage area 305, or if the UE 115-b is outside of the coverage are 305 and likely to move within the coverage area 305, the network entity 105-a may transmit the LP-WUS 325. If the UE 115-b is within the coverage area 305 and likely to move outside of the coverage area 305, or if the UE 115-b is outside of the coverage are 305 and likely to remain outside of the coverage area 305, the network entity 105-a may not transmit the LP-WUS 325. In such examples, the network entity 105-a may transmit a paging early indication (PEI) or paging physical downlink shared channel (PDSCH) or physical downlink control channel (PDSCH) (e.g., instead of the LP-WUS 325).

Additionally, or alternatively, the network entity 105-a may adapt an LP-WUS transmission configuration based on an estimated RSRP budget of the UE 115-b (e.g., if the UE 115-b is stationary or pseudo-stationary). For example, the network entity 105-b may transmit the LP-WUS 325 with power back-off (e.g., with a relatively lower transmission power), with repetition, without repetition, with an adjusted WUS duty cycle, continuously, and so on. The UE 115-b may indicate the estimated RSRP budget via one or more measurement reports to the network entity 105-a.

As an illustrative example, the network entity 105-a (e.g., a DU 165) may determine whether the UE 115-b is within the coverage area 305 and whether the UE 115-b is stationary or pseudo-stationary (e.g., with a speed or likelihood of leaving the coverage area 305 that is less than a threshold). The network entity 105-b may additionally, or alternatively, estimate an RSRP margin of the UE 115-b (e.g., whether a transmit power of the LP-WUS 325 may be decreased based on an RSRP budget or proximity of the UE 115-b). The network entity 105-a may provide LP-WUS information to a second network entity 105 (e.g., the CU 160, an AMF, a core network) when the UE 115-b enters an inactive or idle state (e.g., in examples in which the network entity 105-a removes or stops storing UE context associated with the UE 115-b). For example, the LP-WUS information may include the movement information 330, the coverage state information 335, whether or not the network entity 105-a may transmit the LP-WUS 325, the RSRP margin, an estimated RSRP, a recommended transmission configuration for the LP-WUS 325, and so on. The other network entity 105 may provide the information to the network entity 105-a at a time at which the network entity 105-a may page the UE 115-b (e.g., by transmitting the LP-WUS 325).

In some examples, the network entity 105-a may generate a recommended SSB list (e.g., a list of SSBs or beam directions in which the network entity 105-a identifies stationary or pseudo-stationary UEs 115) based on the movement information 330, the coverage state information 335, or both. The network entity 105-a may provide the list of SSBs to the second network entity 105 (e.g., the CU 160). The second network entity 105 may provide the list to the network entity 105-a at a time at which the network entity 105-a may transmit LP-WUSs 325 to one or more UEs 115, and the network entity 105-a may accordingly transmit the LP-WUS 325 in one or more beam directions indicated by the list.

In some examples, another network entity 105 (e.g., the CU 160, a core network, an AMF) may act as a decision-making entity that may instruct the network entity 105-a whether to transmit the LP-WUS 325 (e.g., or an LP-WUS configuration for the network entity 105-a to use to transmit the LP-WUS 325). In such examples, the other network entity 105 may obtain the movement information 330 and the coverage state information 335 from the UE 115-b, from the network entity 105-a, or from another network entity 105 (e.g., the CU 160), and may determine whether the network entity 105-a may transmit the LP-WUS 325 based on the movement information 330 and the coverage state information 335.

In some examples, the network entity 105-a may notify the UE 115-b (e.g., via broadcast or dedicated messaging) whether the network entity 105-a may selectively transmit the LP-WUS 325 based on the coverage state information 335 and the movement information 330. For example, the network entity 105-a may transmit a request to the UE 115-b indicating for the UE 115-b to collect one or more measurements (e.g., RSRP measurements) and send one or more measurement reports (e.g., to the network entity 105-a, to the CU 160) indicating the movement information 330 and the coverage state information 335. The network entity 105-a may notify the UE 115-b to determine LP-WUS coverage information (e.g., the coverage state information 335) while the UE 115-b is in an active state. Additionally, or alternatively, the UE 115-b may determine to transmit assistance information (e.g., including the movement information 330 or the coverage state information 335) to the network entity 105-a based on receiving an indication that the network entity 105-a may selectively transmit the LP-WUS 325 based on the coverage state information 335 and the movement information 330.

In some examples, the network entity 105-a may incorrectly determine that the UE 115-b is outside of the coverage area 305 and may accordingly transmit a PEI or paging message (e.g., a PDCCH or PDSCH). Accordingly, if the UE 115-b does not respond to the PEI or paging message, the network entity 105-a may determine that the UE 115-b missed the PEI or paging message. In such examples, upon determining that the UE 115-b missed paging, the network entity 105-a may transmit the LP-WUS 325 to the UE 115-b (e.g., during a next duty cycle). Similarly, if the UE 115-b does not respond to an LP-WUS 325, the network entity 105-a may determine that the UE 115-b is outside of the coverage area 305. The network entity 105-a may accordingly transmit a PEI or paging message during the next duty cycle.

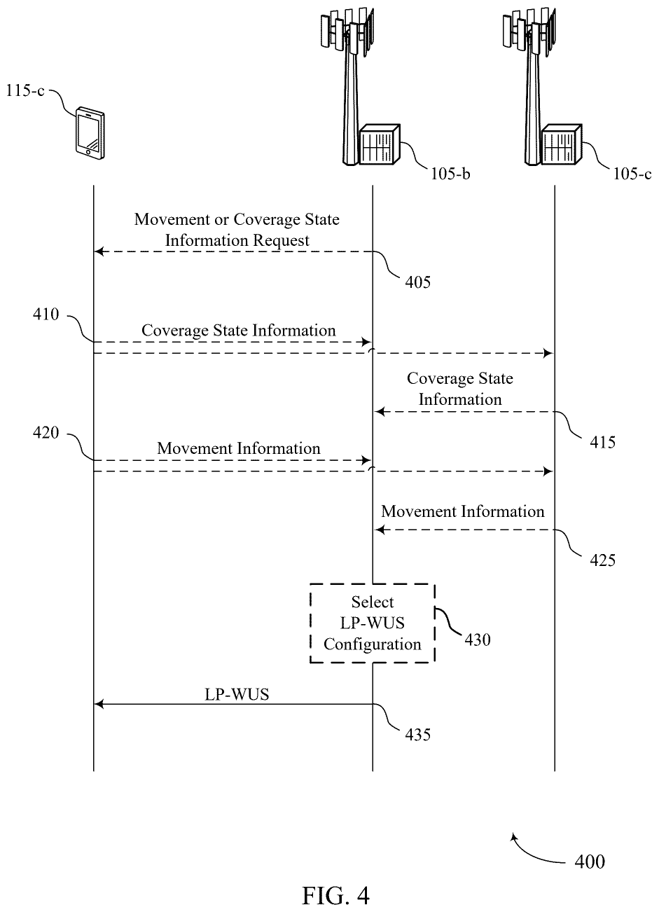

FIG. 4 shows an example of a process flow 400 that supports enhanced LP-WUS transmission for network energy savings in accordance with one or more aspects of the present disclosure. The process flow 400 may implement or may be implemented by aspects of the wireless communications system 100, the network architecture 200, or the wireless communications system 300. For example, the process flow 400 may be implemented by a UE 115 (e.g., a UE 115-c) or one or more network entities 105 (e.g., a network entity 105-b, a network entity 105-c), which may be examples of the corresponding devices as described with reference to FIG. 1. In some examples, the network entity 105-b and the network entity 105-c may be examples of a DU 165 or a CU 160, as described with reference to FIG. 2.

In the following description of the process flow 400, the operations between the UE 115-c, the network entity 105-b, and the network entity 105-c may occur in a different order than the example order shown and, in some examples, may be performed by one or more different devices other than those shown as examples. Some operations also may be omitted from the process flow 400, and other operations may be added to the process flow 400. Further, although some operations or signaling may be shown to occur at different times for discussion purposes, these operations may actually occur at the same time.

In some examples, at 405, the network entity 105-b may output, to the UE 115-c, a message including a request for movement information, coverage state information, or both associated with the UE 115-c. For example, the message may indicate for the UE 115-c to provide one or more measurement reports indicating the movement information or coverage state information. The message may indicate for the UE 115-c to output the movement information or coverage state information to the network entity 105-b (e.g., a DU) or to the network entity 105-c (e.g., a CU).

In some examples, the movement information may include a likelihood that the UE 115-c will remain within a coverage area, a time during which the UE 115-c will remain within the coverage area, or both. The coverage state information may include a size of the coverage area, an indication of whether the UE 115-c is within the coverage area, an estimated pathloss, an estimated reference signal received power, a distance from the UE 115-c to the first network entity, or one or more divisions of the coverage area. In some examples, the coverage area may be an area within which a LP-WUR of the UE 115-c is able to receive signaling from the network entity 105-b. For example, a radius of the coverage area may be the same as a radius of a coverage area of the LP-WUR of the UE 115-c.

At 410, the UE 115-c may transmit the coverage state information to the network entity 105-b, the network entity 105-c, or both. For example, the UE 115-c may output one or more measurement reports indicating the coverage state information. Additionally, or alternatively, the UE 115-c may output a message including an explicit indication of the coverage state information. The UE 115-c may output the coverage state information in response to the request from the network entity 105-b. In some examples (e.g., if the UE 115-c transmitted the coverage state information to the network entity 105-b), at 415, the network the network entity 105-b may obtain the coverage state information from the network entity 105-c.

At 420, the UE 115-c may transmit the movement information to the network entity 105-b, the network entity 105-c, or both. For example, the UE 115-c may output one or more measurement reports indicating the movement information. Additionally, or alternatively, the UE 115-c may output a message including an explicit indication of the movement information. The UE 115-c may output the movement information in response to the request from the network entity 105-b. In some examples (e.g., if the UE 115-c transmitted the movement information to the network entity 105-b), at 425, the network the network entity 105-b may obtain the movement information from the network entity 105-c.

In some examples, at 430, the network entity 105-b may select a LP-WUS configuration (e.g., from one or more LP-WUS configurations). The LP-WUS configuration may include a coding rate, a transmission power, a quantity of repetitions, and the like for a LP-WUS. In some examples, the network entity 105-b may select the LP-WUS configuration based on the movement information, the coverage state information, or both.

At 435, the network entity 105-b may transmit the LP-WUS (e.g., according to the selected LP-WUS configuration). For example, if the movement information and the coverage state information indicate that the UE 115-c is within the coverage area and that the UE 115-c may not move out of the coverage area, the network entity 105-c may transmit the LP-WUS. In some examples, the network entity 105-b may transmit the LP-WUS based on the movement information satisfying one or more thresholds (e.g., a threshold likelihood that the UE 115-c may remain in the coverage area, a threshold time during which the UE 115-c may remain in the coverage area). The network entity 105-b may refrain from transmitting the LP-WUS in examples in which the UE 115-c is not in the coverage area or in examples in which the movement information does not satisfy the one or more thresholds.

The network entity 105-b may transmit the LP-WUS in one or more beam directions based on the coverage state information and the movement information. For example, the network entity 105-b may select a beam direction in which to transmit the LP-WUS based on a location of the UE 115-c, a direction of movement of the UE 115-c, a speed of movement of the UE 115-c, and so on.

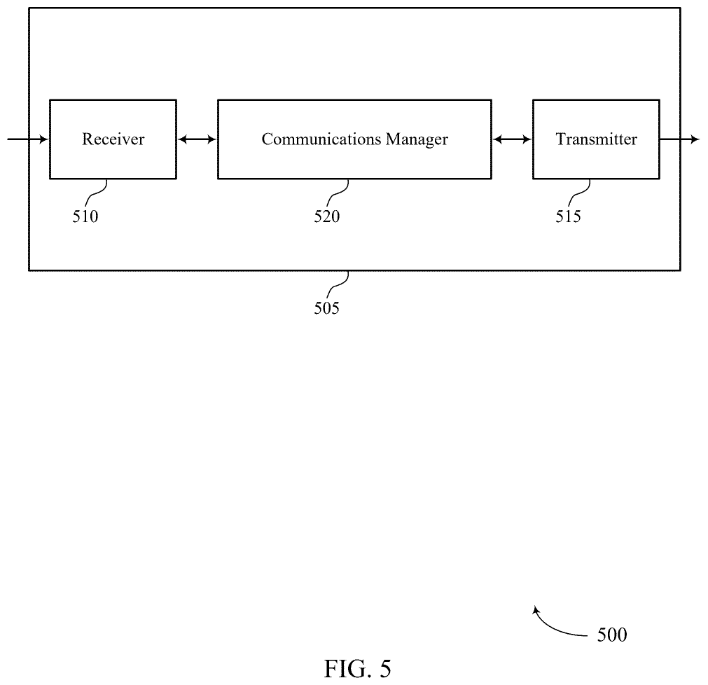

FIG. 5 shows a block diagram 500 of a device 505 that supports enhanced LP-WUS transmission for network energy savings in accordance with one or more aspects of the present disclosure. The device 505 may be an example of aspects of a network entity 105 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The communications manager 520, the receiver 510, the transmitter 515, or various combinations or components thereof may be examples of means for performing various aspects of enhanced LP-WUS transmission for network energy savings as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for obtaining coverage state information for a LP-WUR associated with a UE. The communications manager 520 is capable of, configured to, or operable to support a means for obtaining movement information associated with the UE. The communications manager 520 is capable of, configured to, or operable to support a means for transmitting, to the UE, a LP-WUS based on the UE being within a coverage area associated with the LP-WUR according to the coverage state information and based on the movement information associated with the UE satisfying one or more movement information thresholds.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for selectively transmitting LP-WUSs based on location and movement information of a UE, which may result in reduced power consumption and more efficient utilization of communication resources.

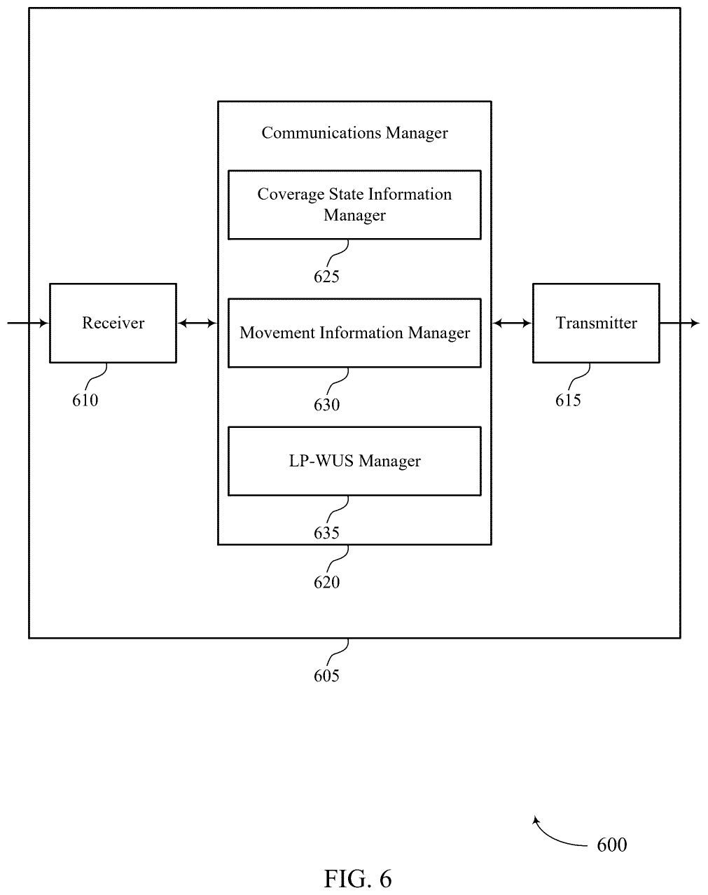

FIG. 6 shows a block diagram 600 of a device 605 that supports enhanced LP-WUS transmission for network energy savings in accordance with one or more aspects of the present disclosure. The device 605 may be an example of aspects of a device 505 or a network entity 105 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The device 605, or various components thereof, may be an example of means for performing various aspects of enhanced LP-WUS transmission for network energy savings as described herein. For example, the communications manager 620 may include a coverage state information manager 625, a movement information manager 630, an LP-WUS manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The coverage state information manager 625 is capable of, configured to, or operable to support a means for obtaining coverage state information for a LP-WUR associated with a UE. The movement information manager 630 is capable of, configured to, or operable to support a means for obtaining movement information associated with the UE. The LP-WUS manager 635 is capable of, configured to, or operable to support a means for transmitting, to the UE, a LP-WUS based on the UE being within a coverage area associated with the LP-WUR according to the coverage state information and based on the movement information associated with the UE satisfying one or more movement information thresholds.

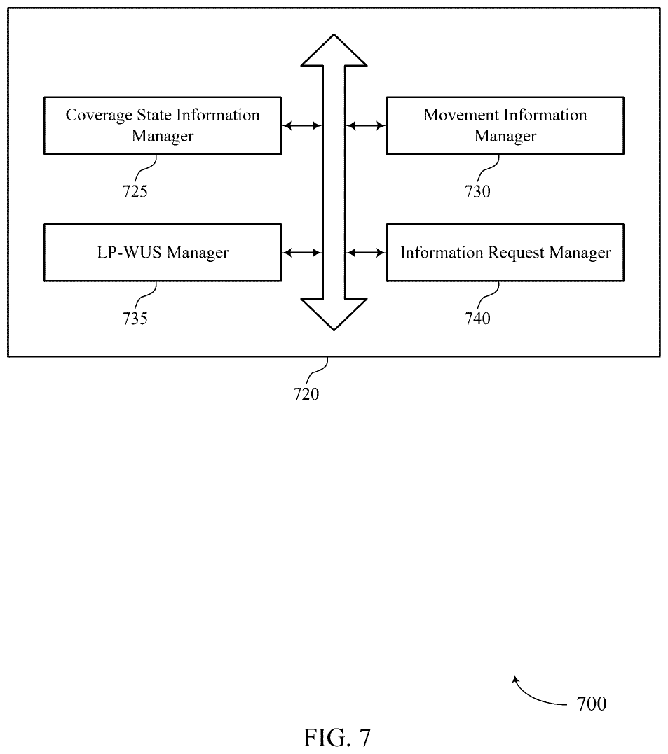

FIG. 7 shows a block diagram 700 of a communications manager 720 that supports enhanced LP-WUS transmission for network energy savings in accordance with one or more aspects of the present disclosure. The communications manager 720 may be an example of aspects of a communications manager 520, a communications manager 620, or both, as described herein. The communications manager 720, or various components thereof, may be an example of means for performing various aspects of enhanced LP-WUS transmission for network energy savings as described herein. For example, the communications manager 720 may include a coverage state information manager 725, a movement information manager 730, an LP-WUS manager 735, an information request manager 740, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 720 may support wireless communications in accordance with examples as disclosed herein. The coverage state information manager 725 is capable of, configured to, or operable to support a means for obtaining coverage state information for a LP-WUR associated with a UE. The movement information manager 730 is capable of, configured to, or operable to support a means for obtaining movement information associated with the UE. The LP-WUS manager 735 is capable of, configured to, or operable to support a means for transmitting, to the UE, a LP-WUS based on the UE being within a coverage area associated with the LP-WUR according to the coverage state information and based on the movement information associated with the UE satisfying one or more movement information thresholds.

In some examples, to support transmitting the LP-WUS, the LP-WUS manager 735 is capable of, configured to, or operable to support a means for transmitting the LP-WUS according to a LP-WUS configuration, where the LP-WUS configuration includes a coding rate, a transmission power, or a quantity of repetitions, or any combination thereof.

In some examples, the LP-WUS manager 735 is capable of, configured to, or operable to support a means for selecting the LP-WUS configuration based on the coverage state information and the movement information.

In some examples, to support transmitting the LP-WUS, the LP-WUS manager 735 is capable of, configured to, or operable to support a means for transmitting the LP-WUS in one or more beam directions, where the one or more beam directions are based on the coverage state information and the movement information.

In some examples, to support obtaining the coverage state information, the coverage state information manager 725 is capable of, configured to, or operable to support a means for obtaining, from the UE, a message indicating the coverage state information.

In some examples, to support obtaining the coverage state information, the coverage state information manager 725 is capable of, configured to, or operable to support a means for obtaining one or more measurement reports from the UE, where the one or more measurement reports indicate the coverage state information.

In some examples, to support obtaining the coverage state information, the coverage state information manager 725 is capable of, configured to, or operable to support a means for obtaining, from a second network entity, a message indicating the coverage state information.

In some examples, to support obtaining the movement information, the movement information manager 730 is capable of, configured to, or operable to support a means for obtaining, from the UE, a message indicating the movement information.

In some examples, to support obtaining the movement information, the movement information manager 730 is capable of, configured to, or operable to support a means for obtaining, from a second network entity, a message indicating the movement information.

In some examples, the information request manager 740 is capable of, configured to, or operable to support a means for outputting a message indicating for the UE to provide, to the first network entity or to a second network entity, the movement information, the coverage state information, or both.

In some examples, the movement information includes a likelihood that the UE will remain within the coverage area, a time during which the UE will remain within the coverage area, or both. In some examples, the one or more movement information thresholds include a threshold likelihood, a threshold time, or both.

In some examples, the coverage state information includes a size of the coverage area, an indication of whether the UE is within the coverage area, an estimated pathloss, an estimated reference signal received power, a distance from the UE to the first network entity, one or more divisions of the coverage area, or any combination thereof.

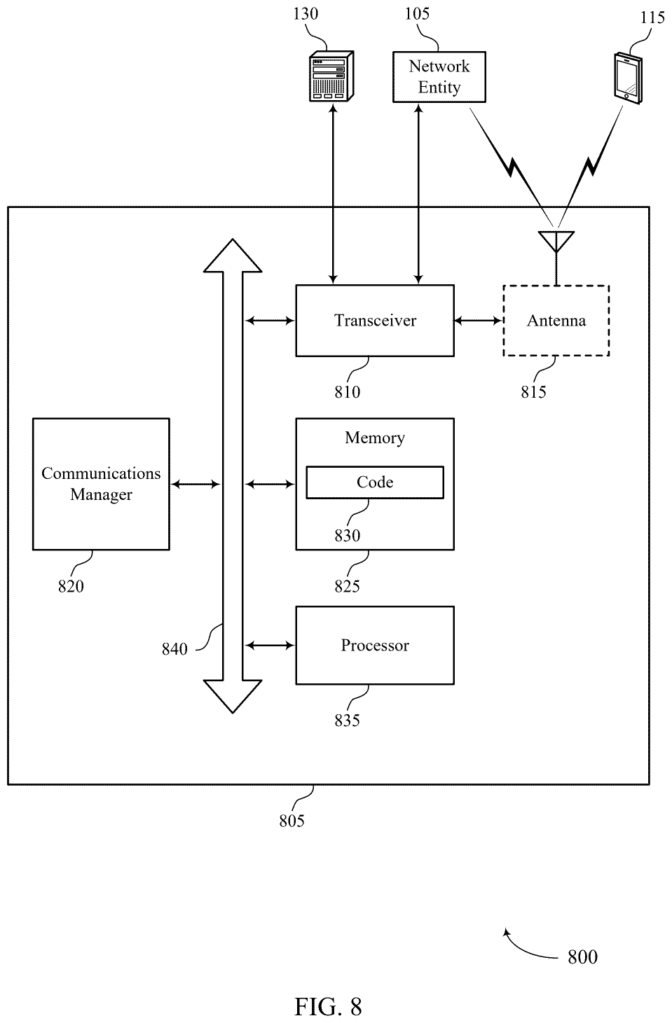

FIG. 8 shows a diagram of a system 800 including a device 805 that supports enhanced LP-WUS transmission for network energy savings in accordance with one or more aspects of the present disclosure. The device 805 may be an example of or include components of a device 505, a device 605, or a network entity 105 as described herein. The device 805 may communicate with other network devices or network equipment such as one or more of the network entities 105, UEs 115, or any combination thereof. The communications may include communications over one or more wired interfaces, over one or more wireless interfaces, or any combination thereof. The device 805 may include components that support outputting and obtaining communications, such as a communications manager 820, a transceiver 810, one or more antennas 815, at least one memory 825, code 830, and at least one processor 835. These components may be in electronic communication or otherwise coupled (e.g., operatively, communicatively, functionally, electronically, electrically) via one or more buses (e.g., a bus 840).

The transceiver 810 may support bi-directional communications via wired links, wireless links, or both as described herein. In some examples, the transceiver 810 may include a wired transceiver and may communicate bi-directionally with another wired transceiver. Additionally, or alternatively, in some examples, the transceiver 810 may include a wireless transceiver and may communicate bi-directionally with another wireless transceiver. In some examples, the device 805 may include one or more antennas 815, which may be capable of transmitting or receiving wireless transmissions (e.g., concurrently). The transceiver 810 may also include a modem to modulate signals, to provide the modulated signals for transmission (e.g., by one or more antennas 815, by a wired transmitter), to receive modulated signals (e.g., from one or more antennas 815, from a wired receiver), and to demodulate signals. In some implementations, the transceiver 810 may include one or more interfaces, such as one or more interfaces coupled with the one or more antennas 815 that are configured to support various receiving or obtaining operations, or one or more interfaces coupled with the one or more antennas 815 that are configured to support various transmitting or outputting operations, or a combination thereof. In some implementations, the transceiver 810 may include or be configured for coupling with one or more processors or one or more memory components that are operable to perform or support operations based on received or obtained information or signals, or to generate information or other signals for transmission or other outputting, or any combination thereof. In some implementations, the transceiver 810, or the transceiver 810 and the one or more antennas 815, or the transceiver 810 and the one or more antennas 815 and one or more processors or one or more memory components (e.g., the at least one processor 835, the at least one memory 825, or both), may be included in a chip or chip assembly that is installed in the device 805. In some examples, the transceiver 810 may be operable to support communications via one or more communications links (e.g., communication link(s) 125, backhaul communication link(s) 120, a midhaul communication link 162, a fronthaul communication link 168).

The at least one memory 825 may include RAM, ROM, or any combination thereof. The at least one memory 825 may store computer-readable, computer-executable, or processor-executable code, such as the code 830. The code 830 may include instructions that, when executed by one or more of the at least one processor 835, cause the device 805 to perform various functions described herein. The code 830 may be stored in a non-transitory computer-readable medium such as system memory or another type of memory. In some cases, the code 830 may not be directly executable by a processor of the at least one processor 835 but may cause a computer (e.g., when compiled and executed) to perform functions described herein. In some cases, the at least one memory 825 may include, among other things, a BIOS which may control basic hardware or software operation such as the interaction with peripheral components or devices. In some examples, the at least one processor 835 may include multiple processors and the at least one memory 825 may include multiple memories. One or more of the multiple processors may be coupled with one or more of the multiple memories which may, individually or collectively, be configured to perform various functions herein (for example, as part of a processing system).

The at least one processor 835 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 835 may be configured to operate a memory array using a memory controller. In some other cases, a memory controller may be integrated into one or more of the at least one processor 835. The at least one processor 835 may be configured to execute computer-readable instructions stored in a memory (e.g., one or more of the at least one memory 825) to cause the device 805 to perform various functions (e.g., functions or tasks supporting enhanced LP-WUS transmission for network energy savings). For example, the device 805 or a component of the device 805 may include at least one processor 835 and at least one memory 825 coupled with one or more of the at least one processor 835, the at least one processor 835 and the at least one memory 825 configured to perform various functions described herein. The at least one processor 835 may be an example of a cloud-computing platform (e.g., one or more physical nodes and supporting software such as operating systems, virtual machines, or container instances) that may host the functions (e.g., by executing code 830) to perform the functions of the device 805. The at least one processor 835 may be any one or more suitable processors capable of executing scripts or instructions of one or more software programs stored in the device 805 (such as within one or more of the at least one memory 825).

In some examples, the at least one processor 835 may include multiple processors and the at least one memory 825 may include multiple memories. One or more of the multiple processors may be coupled with one or more of the multiple memories, which may, individually or collectively, be configured to perform various functions herein. In some examples, the at least one processor 835 may be a component of a processing system, which may refer to a system (such as a series) of machines, circuitry (including, for example, one or both of processor circuitry (which may include the at least one processor 835) and memory circuitry (which may include the at least one memory 825)), or components, that receives or obtains inputs and processes the inputs to produce, generate, or obtain a set of outputs. The processing system may be configured to perform one or more of the functions described herein. For example, the at least one processor 835 or a processing system including the at least one processor 835 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 825 or otherwise, to perform one or more of the functions described herein.

In some examples, a bus 840 may support communications of (e.g., within) a protocol layer of a protocol stack. In some examples, a bus 840 may support communications associated with a logical channel of a protocol stack (e.g., between protocol layers of a protocol stack), which may include communications performed within a component of the device 805, or between different components of the device 805 that may be co-located or located in different locations (e.g., where the device 805 may refer to a system in which one or more of the communications manager 820, the transceiver 810, the at least one memory 825, the code 830, and the at least one processor 835 may be located in one of the different components or divided between different components).

In some examples, the communications manager 820 may manage aspects of communications with a core network 130 (e.g., via one or more wired or wireless backhaul links). For example, the communications manager 820 may manage the transfer of data communications for client devices, such as one or more UEs 115. In some examples, the communications manager 820 may manage communications with one or more other network entities 105, and may include a controller or scheduler for controlling communications with UEs 115 (e.g., in cooperation with the one or more other network devices). In some examples, the communications manager 820 may support an X2 interface within an LTE/LTE-A wireless communications network technology to provide communication between network entities 105.

The communications manager 820 may support wireless communications in accordance with examples as disclosed herein. For example, the communications manager 820 is capable of, configured to, or operable to support a means for obtaining coverage state information for a LP-WUR associated with a UE. The communications manager 820 is capable of, configured to, or operable to support a means for obtaining movement information associated with the UE. The communications manager 820 is capable of, configured to, or operable to support a means for transmitting, to the UE, a LP-WUS based on the UE being within a coverage area associated with the LP-WUR according to the coverage state information and based on the movement information associated with the UE satisfying one or more movement information thresholds.

By including or configuring the communications manager 820 in accordance with examples as described herein, the device 805 may support techniques for selectively transmitting LP-WUSs based on location and movement information of a UE, which may result in reduced power consumption, more efficient utilization of communication resources, longer battery life, and improved utilization of processing capability.

In some examples, the communications manager 820 may be configured to perform various operations (e.g., receiving, obtaining, monitoring, outputting, transmitting) using or otherwise in cooperation with the transceiver 810, the one or more antennas 815 (e.g., where applicable), or any combination thereof. Although the communications manager 820 is illustrated as a separate component, in some examples, one or more functions described with reference to the communications manager 820 may be supported by or performed by the transceiver 810, one or more of the at least one processor 835, one or more of the at least one memory 825, the code 830, or any combination thereof (for example, by a processing system including at least a portion of the at least one processor 835, the at least one memory 825, the code 830, or any combination thereof). For example, the code 830 may include instructions executable by one or more of the at least one processor 835 to cause the device 805 to perform various aspects of enhanced LP-WUS transmission for network energy savings as described herein, or the at least one processor 835 and the at least one memory 825 may be otherwise configured to, individually or collectively, perform or support such operations.

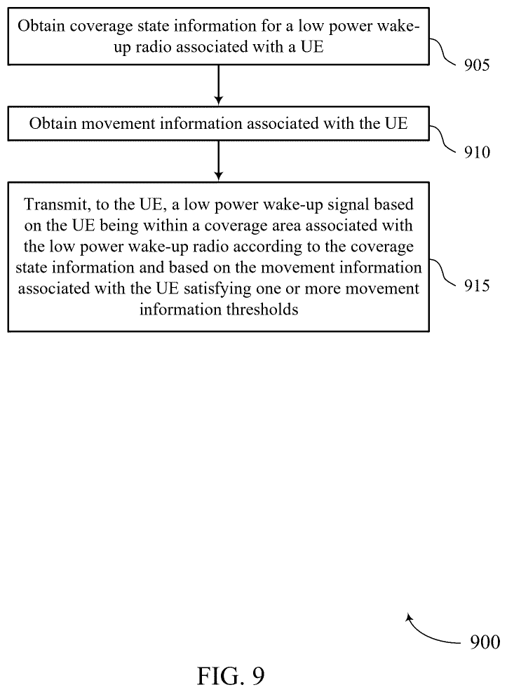

FIG. 9 shows a flowchart illustrating a method 900 that supports enhanced LP-WUS transmission for network energy savings in accordance with one or more aspects of the present disclosure. The operations of the method 900 may be implemented by a network entity or its components as described herein. For example, the operations of the method 900 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 905, the method may include obtaining coverage state information for a LP-WUR associated with a UE. The operations of 905 may be performed in accordance with examples as disclosed herein. In some examples, aspects of the operations of 905 may be performed by a coverage state information manager 725 as described with reference to FIG. 7.

At 910, the method may include obtaining movement information associated with the UE. The operations of 910 may be performed in accordance with examples as disclosed herein. In some examples, aspects of the operations of 910 may be performed by a movement information manager 730 as described with reference to FIG. 7.

At 915, the method may include transmitting, to the UE, a LP-WUS based on the UE being within a coverage area associated with the LP-WUR according to the coverage state information and based on the movement information associated with the UE satisfying one or more movement information thresholds. The operations of 915 may be performed in accordance with examples as disclosed herein. In some examples, aspects of the operations of 915 may be performed by an LP-WUS manager 735 as described with reference to FIG. 7.

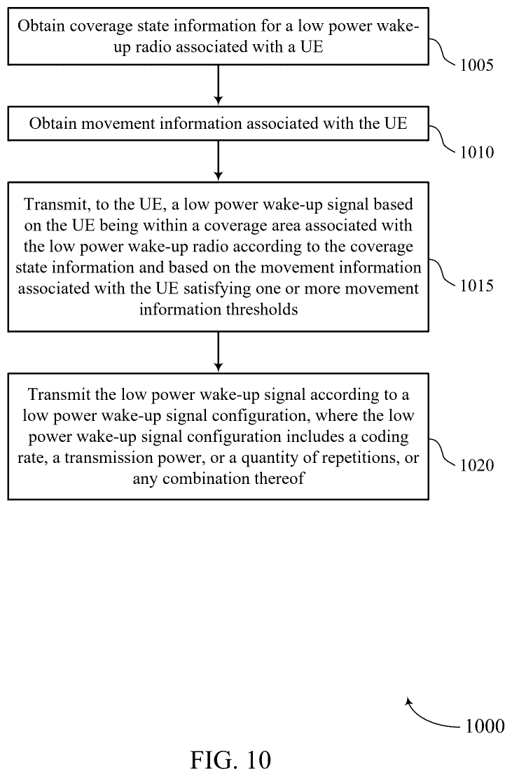

FIG. 10 shows a flowchart illustrating a method 1000 that supports enhanced LP-WUS transmission for network energy savings in accordance with one or more aspects of the present disclosure. The operations of the method 1000 may be implemented by a network entity or its components as described herein. For example, the operations of the method 1000 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1005, the method may include obtaining coverage state information for a LP-WUR associated with a UE. The operations of 1005 may be performed in accordance with examples as disclosed herein. In some examples, aspects of the operations of 1005 may be performed by a coverage state information manager 725 as described with reference to FIG. 7.

At 1010, the method may include obtaining movement information associated with the UE. The operations of 1010 may be performed in accordance with examples as disclosed herein. In some examples, aspects of the operations of 1010 may be performed by a movement information manager 730 as described with reference to FIG. 7.

At 1015, the method may include transmitting, to the UE, a LP-WUS based on the UE being within a coverage area associated with the LP-WUR according to the coverage state information and based on the movement information associated with the UE satisfying one or more movement information thresholds. The operations of 1015 may be performed in accordance with examples as disclosed herein. In some examples, aspects of the operations of 1015 may be performed by an LP-WUS manager 735 as described with reference to FIG. 7.

At 1020, the method may include transmitting the LP-WUS according to a LP-WUS configuration, where the LP-WUS configuration includes a coding rate, a transmission power, or a quantity of repetitions, or any combination thereof. The operations of 1020 may be performed in accordance with examples as disclosed herein. In some examples, aspects of the operations of 1020 may be performed by an LP-WUS manager 735 as described with reference to FIG. 7.

The following provides an overview of aspects of the present disclosure:

Aspect 1: A method for wireless communications by a first network entity, comprising: obtaining coverage state information for a LP-WUR associated with a UE; obtaining movement information associated with the UE; and transmitting, to the UE, a LP-WUS based at least in part on the UE being within a coverage area associated with the LP-WUR according to the coverage state information and based at least in part on the movement information associated with the UE satisfying one or more movement information thresholds.

Aspect 2: The method of aspect 1, wherein transmitting the LP-WUS comprises: transmitting the LP-WUS according to a LP-WUS configuration, wherein the LP-WUS configuration comprises a coding rate, a transmission power, or a quantity of repetitions, or any combination thereof.

Aspect 3: The method of aspect 2, further comprising: selecting the LP-WUS configuration based at least in part on the coverage state information and the movement information.

Aspect 4: The method of any of aspects 1 through 3, wherein transmitting the LP-WUS comprises: transmitting the LP-WUS in one or more beam directions, wherein the one or more beam directions are based at least in part on the coverage state information and the movement information.

Aspect 5: The method of any of aspects 1 through 4, wherein obtaining the coverage state information comprises: obtaining, from the UE, a message indicating the coverage state information.

Aspect 6: The method of aspect 5, wherein obtaining the coverage state information comprises: obtaining one or more measurement reports from the UE, wherein the one or more measurement reports indicate the coverage state information.

Aspect 7: The method of any of aspects 1 through 6, wherein obtaining the coverage state information comprises: obtaining, from a second network entity, a message indicating the coverage state information.

Aspect 8: The method of any of aspects 1 through 7, wherein obtaining the movement information comprises: obtaining, from the UE, a message indicating the movement information.

Aspect 9: The method of any of aspects 1 through 8, wherein obtaining the movement information comprises: obtaining, from a second network entity, a message indicating the movement information.

Aspect 10: The method of any of aspects 1 through 9, further comprising: outputting a message indicating for the UE to provide, to the first network entity or to a second network entity, the movement information, the coverage state information, or both.

Aspect 11: The method of any of aspects 1 through 10, wherein the movement information comprises a likelihood that the UE will remain within the coverage area, a time during which the UE will remain within the coverage area, or both, the one or more movement information thresholds comprise a threshold likelihood, a threshold time, or both.

Aspect 12: The method of any of aspects 1 through 11, wherein the coverage state information comprises a size of the coverage area, an indication of whether the UE is within the coverage area, an estimated pathloss, an estimated RSRP, a distance from the UE to the first network entity, one or more divisions of the coverage area, or any combination thereof.

Aspect 13: A first network entity for wireless communications, comprising one or more memories storing processor-executable code, and one or more processors coupled with the one or more memories and individually or collectively operable to execute the code to cause the first network entity to perform a method of any of aspects 1 through 12.

Aspect 14: A first network entity for wireless communications, comprising at least one means for performing a method of any of aspects 1 through 12.

Aspect 15: A non-transitory computer-readable medium storing code for wireless communications, the code comprising instructions executable by one or more processors to perform a method of any of aspects 1 through 12.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first network entity, comprising:
one or more memories storing processor-executable code; and
one or more processors coupled with the one or more memories and individually or collectively operable to execute the code to cause the first network entity to:
obtain coverage state information for a low power wake-up radio associated with a user equipment (UE);
obtain movement information associated with the UE; and
transmit, to the UE, a low power wake-up signal based at least in part on the UE being within a coverage area associated with the low power wake-up radio according to the coverage state information and based at least in part on the movement information associated with the UE satisfying one or more movement information thresholds.

2. The first network entity of claim 1, wherein, to transmit the low power wake-up signal, the one or more processors are individually or collectively operable to execute the code to cause the first network entity to:
transmit the low power wake-up signal according to a low power wake-up signal configuration, wherein the low power wake-up signal configuration comprises a coding rate, a transmission power, or a quantity of repetitions, or any combination thereof.

3. The first network entity of claim 2, wherein the one or more processors are individually or collectively further operable to execute the code to cause the first network entity to:
select the low power wake-up signal configuration based at least in part on the coverage state information and the movement information.

4. The first network entity of claim 1, wherein, to transmit the low power wake-up signal, the one or more processors are individually or collectively operable to execute the code to cause the first network entity to:
transmit the low power wake-up signal in one or more beam directions, wherein the one or more beam directions are based at least in part on the coverage state information and the movement information.

5. The first network entity of claim 1, wherein, to obtain the coverage state information, the one or more processors are individually or collectively operable to execute the code to cause the first network entity to:
obtain, from the UE, a message indicating the coverage state information.

6. The first network entity of claim 5, wherein, to obtain the coverage state information, the one or more processors are individually or collectively operable to execute the code to cause the first network entity to:
obtain one or more measurement reports from the UE, wherein the one or more measurement reports indicate the coverage state information.

7. The first network entity of claim 1, wherein, to obtain the coverage state information, the one or more processors are individually or collectively operable to execute the code to cause the first network entity to:
obtain, from a second network entity, a message indicating the coverage state information.

8. The first network entity of claim 1, wherein, to obtain the movement information, the one or more processors are individually or collectively operable to execute the code to cause the first network entity to:
obtain, from the UE, a message indicating the movement information.

9. The first network entity of claim 1, wherein, to obtain the movement information, the one or more processors are individually or collectively operable to execute the code to cause the first network entity to:
obtain, from a second network entity, a message indicating the movement information.

10. The first network entity of claim 1, wherein the one or more processors are individually or collectively further operable to execute the code to cause the first network entity to:
output a message indicating for the UE to provide, to the first network entity or to a second network entity, the movement information, the coverage state information, or both.

11. The first network entity of claim 1, wherein the movement information comprises a likelihood that the UE will remain within the coverage area, a time during which the UE will remain within the coverage area, or both, and wherein the one or more movement information thresholds comprise a threshold likelihood, a threshold time, or both.

12. The first network entity of claim 1, wherein the coverage state information comprises a size of the coverage area, an indication of whether the UE is within the coverage area, an estimated pathloss, an estimated reference signal received power, a distance from the UE to the first network entity, one or more divisions of the coverage area, or any combination thereof.

13. A method for wireless communications by a first network entity, comprising:
obtaining coverage state information for a low power wake-up radio associated with a user equipment (UE);
obtaining movement information associated with the UE; and
transmitting, to the UE, a low power wake-up signal based at least in part on the UE being within a coverage area associated with the low power wake-up radio according to the coverage state information and based at least in part on the movement information associated with the UE satisfying one or more movement information thresholds.

14. The method of claim 13, wherein transmitting the low power wake-up signal comprises:
transmitting the low power wake-up signal according to a low power wake-up signal configuration, wherein the low power wake-up signal configuration comprises a coding rate, a transmission power, or a quantity of repetitions, or any combination thereof.

15. The method of claim 14, further comprising:
selecting the low power wake-up signal configuration based at least in part on the coverage state information and the movement information.

16. The method of claim 13, wherein transmitting the low power wake-up signal comprises:
transmitting the low power wake-up signal in one or more beam directions, wherein the one or more beam directions are based at least in part on the coverage state information and the movement information.

17. The method of claim 13, wherein obtaining the coverage state information comprises:
obtaining, from the UE, a message indicating the coverage state information.

18. The method of claim 17, wherein obtaining the coverage state information comprises:
obtaining one or more measurement reports from the UE, wherein the one or more measurement reports indicate the coverage state information.

19. The method of claim 13, wherein obtaining the coverage state information comprises:
obtaining, from a second network entity, a message indicating the coverage state information.

20. A non-transitory computer-readable medium storing code for wireless communications, the code comprising instructions executable by one or more processors to:
obtain coverage state information for a low power wake-up radio associated with a user equipment (UE);
obtain movement information associated with the UE; and
transmit, to the UE, a low power wake-up signal based at least in part on the UE being within a coverage area associated with the low power wake-up radio according to the coverage state information and based at least in part on the movement information associated with the UE satisfying one or more movement information thresholds.
